(19) United States
(12) Patent Application Publication
(10) Pub. No.: US 2015/0336580 A1
(43) Pub. Date: Nov. 26, 2015

(54) Method and Controller for Enabling a Constant Speed Drive System, Engine Unit Comprising such a Controller and Vehicle Comprising such an Engine Unit

(71) Applicant: CATERPILLAR INC., Peoria, IL (US)

(72) Inventors: Arick Bakken, Raleigh, NC (US); Paul Cairns, Groby, Leicestershire (GB); William Swick, Apex, NC (US)

(73) Assignee: Catrepillar Inc., Peoria, IL (US)

(21) Appl. No.: 14/759,112

(22) PCT Filed: Jan. 7, 2013
(86) PCT No.: PCT/US2013/020497

§ 371 Date: Jul. 2, 2015

(51) Int. Cl. B60W 30/14; B60W 10/18; B60W 10/06

(52) U.S. Cl. CPC B60W 30/143; B60W 10/06; B60W 10/18; B60W 2520/10; B60W 2710/0655; B60W 2710/18

(57) ABSTRACT

When driving a vehicle, constant speed drive may be engaged so that the vehicle can maintain, without any input from the operator, a desired speed, regardless of at least one of the slope on which the vehicle is travelling and the load it is carrying etc. Control of working vehicles may be very demanding on the operator, so it may be desirable to minimize any additional control burdens. The present disclosure may facilitate the engagement of constant speed drive in a vehicle with a non-direct transmission system by considering the stability of a speed of the vehicle and an engine speed demand from the operator.

### TECHNICAL FIELD

This disclosure relates to methods and apparatuses for engaging a constant speed drive system.

### BACKGROUND

Non-direct transmission systems, such as diesel electric, hydrostatic and hydrodynamic transmission systems, generate power in one form and transmit the power in another form. For example, a working vehicle, such as a bulldozer or a snow plough, that has a hydrostatic transmission system may generate mechanical power from an internal combustion engine, such as a diesel engine, and transmit the generated power to the vehicle wheels and any ancillary devices, such as a scoop or plough, using hydraulic power.

The speed of vehicles with hydrodynamic transmission systems is often controlled either by using just the throttle of the vehicle, or by engaging a ‘creeper’ function, locking the throttle demand and using the creeper dial on its own, or by engaging the creeper function and using the creeper dial and throttle in combination. The creeper function may be engaged when the operator desires to travel at low speeds, and it may set a maximum possible vehicle speed of, for example, 12 KPH, when the creeper dial is turned to 100%. The maximum speed of the vehicle may be reduced by changing the position of the creeper dial. In this way, the speed of the engine may be fixed using a throttle lock and the creeper dial used on its own to adjust the speed of the vehicle. If the throttle position has been locked at a position below 100%, the speed of the vehicle may be changed by adjusting the creeper dial and/or increasing the throttle demand to increase the engine speed.

Such a system allows the operator to set the speed of the engine using a throttle, and then control the drive of the wheels and/or the operation of peripheral components using additional controls without having to control the engine speed.

For example, when the vehicle is being driven at low speeds, the operator may lock the throttle position (for example, at 100%) and engage the creeper function so that only the operation of the peripheral components, and the creeper dial if small changes in speed are desired, requires control by the operator.

When moving the vehicle around, it may be desirable to engage a constant speed drive so that the vehicle can maintain, without any input from the operator, a desired speed, regardless of the slope on which the vehicle is travelling, or the load it is carrying etc. This simplifies control of the vehicle because the operator will not need to be concerned about adjustment of the creeper dial in order to maintain a desired speed.

Japanese patent application number JP 2000-6682A describes a vehicle constant speed drive system that engages when all three of the following conditions have been met: the vehicle operator has enabled a switch indicating that they would like constant speed drive to engage; the speed of the vehicle is over 30 KPH; and the speed of the vehicle has been stable for three seconds. Once engaged, the constant speed drive may be disengaged by the operator disabling the switch for constant speed drive, or by engaging the brakes, or by engaging the throttle, or by changing gear.

In this technique, in order to engage the constant speed drive, the operator must control the operation of a constant speed drive switch. This adds a further complexity to the operation of the vehicle, which is particularly significant with working vehicles because they already have complicated control systems that require the operator to manage not just the movement of the vehicle, but also the operation of ancillary devices, such as scoops and digging tools. Furthermore, working vehicles are usually moved around busy, hazardous areas, which even further increases the complexity of vehicle operation.

### SUMMARY

The present disclosure relates to a method of controlling the enablement of a constant speed drive system in a vehicle with a non-direct transmission system, the method comprising the steps of:
enabling the constant speed drive system, if:
a) a speed of the vehicle is stable for a first period of time; and
b) an engine speed demand from an operator of the vehicle is stable for a second period of time.

The present disclosure also relates to a controller for controlling enablement of a constant speed drive system in a vehicle with a non-direct transmission system, the controller being arranged to:
enable the constant speed drive system if:
a) a speed of the vehicle is stable for a first period of time; and
b) an engine speed demand from an operator of the vehicle is stable for a second period of time.

### BRIEF DESCRIPTION OF THE DRAWINGS

A constant speed drive (CSD) engagement control process and apparatus in accordance with the present disclosure is described by way of example only with reference to the accompanying drawings in which:

FIG. 1 shows a control process that may be executed in order to control the engagement of CSD in a vehicle with non-direct transmission in accordance with an aspect of the present disclosure;

FIG. 2 shows a control process that may be executed in order to control the engagement of CSD in a vehicle with non-direct transmission in accordance with a further aspect of the present disclosure;

FIG. 3 shows steps that may be used in the control processes of FIG. 1 or 2 in order to determine if the speed of the vehicle is stable;

FIG. 4 shows a control process that may be executed in order to control the disengagement of CSD in a vehicle with non-direct transmission in accordance with a further aspect of the present disclosure;

FIG. 5 shows a schematic diagram of a control system that may be used in a vehicle with indirect transmission to execute the method steps of FIG. 1, 2, 3 or 4;

FIG. 6 shows an example vehicle, within which the controller of FIG. 5 may be used.

### DETAILED DESCRIPTION

Constant Speed Drive (CSD) is a system of control by which a vehicle may be maintained at a constant speed regardless of the slope of the surface on which the vehicle is travelling, or the work that the vehicle is doing etc.

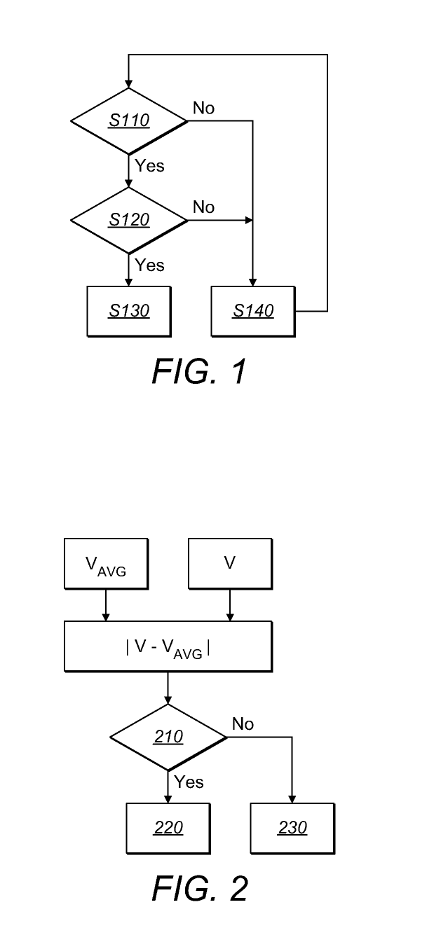

FIG. 1 shows the steps of a control process that may be executed in accordance with an aspect of the present disclosure in order to determine whether or not CSD may be activated.

The method steps show the process of determining whether or not to activate CSD, so at the first step, S110, the CSD is inactive. In Step S110, it is determined whether or not the engine speed demand has been stable for at least an engine speed demand threshold period of time T_{ACT1}. The vehicle engine may be an internal combustion engine, for example a diesel engine, and the engine speed demand may be set by the position of the throttle, which may be controlled by the operator of the vehicle.

The threshold period of time T_{ACT1} over which the engine speed demand must be stable may be set to any suitable value determined by the skilled person in consideration of various factors that might include vehicle type, engine size and type, and expected vehicle operation conditions. For example, the threshold period of time T_{ACT1} may be 5 seconds, or more preferably 2 seconds.

The stability of the engine speed demand may be determined by considering whether or not an engine speed demand lock, for example a throttle lock, has been activated. A throttle lock acts to lock the engine speed demand at the time the lock is engaged, such that whilst the lock is engaged the engine speed demand cannot be reduced, but may be increased by the operator, for example by changing the throttle position to increase demand.

If the engine speed demand lock has been activated, and during the threshold period T_{ACT1} the engine speed demand has not increased from its level at the time the lock was engaged, the engine speed demand may be considered to have been stable for the threshold period T_{ACT1}. When determining whether or not the engine speed demand has increased from the locked level, it may be arranged that any increase in demand level is considered to be a change, or only any increase above a threshold level, for example 100 RPM the locked demand, is considered to be a change. In this way, small, accidental increases in engine speed demand may be ignored, with only clearly deliberate increases in speed having an effect.

If the engine speed demand lock has not been activated, the engine speed demand may still be considered to be stable if it is above an engine speed demand threshold value V_{ACT1}. The threshold value V_{ACT1} may be set at any suitable value by the skilled person in consideration of various factors that might include vehicle type, engine size and type, and expected vehicle operation conditions. For example, V_{ACT1} may be 60% of the maximum possible engine speed demand, or more preferably 80% of the maximum possible engine speed demand.

Therefore, at step S110, it may be arranged that the engine speed demand is considered to have been stable for the threshold period T_{ACT1} if for the entirety of T_{ACT1} the engine speed demand lock has been on and the engine demand has not increased from the locked position, or the engine speed demand lock has been off and the engine speed demand has exceeded the threshold value V_{ACT1}.

If engine speed demand is considered not to have been stable for the threshold period T_{ACT1}, the control process may proceed to Step S140, where CSD is maintained in a deactivated state. The control method may then return back to S110, as shown in FIG. 1.

If, however, the engine speed demand is considered to have been stable for the entirety of the threshold period T_{ACT1}, the control process may proceed to Step S120, where it is determined whether or not the vehicle speed has been stable for a vehicle speed threshold period of time T_{ACT2}. The threshold period T_{ACT2} may be set to be the same as the threshold period T_{ACT1}, or it may be set to be different.

Vehicle speed may be determined a number of different ways, for example, it may be the speed of the vehicle relative to the surface across which it is travelling, which may be determined using any standard technique. Alternatively, it may, for example, be an angular speed of a motor turning the wheels of the vehicle.

In order to determine if the vehicle speed is stable, an average speed of the vehicle over a recent period of time (i.e. a moving average) may be compared with the current vehicle speed, and if the difference between the current vehicle speed and the moving average of vehicle speed is less than a threshold amount, the vehicle speed may be considered to be stable.

For example, the moving average speed of the vehicle may be determined by storing periodic vehicle speed measurements and then determining the average speed from the values stored over a period of time, for example the preceding three seconds. In this way, the moving average speed may continually update itself with each new speed measurement that is stored. Whilst in this example the period over which the moving average speed is determined is three seconds, it could alternatively be set to any suitable period of time, for example five seconds.

Alternatively, the moving average of vehicle speed may be determined using a weighted average calculation. In this case, vehicle speed measurements may periodically be made and the average of the measurements determined by applying a heavier weighting to the most recent measurements and an increasingly lower weighting to older measurements. In this way, older measurements become increasingly less significant in the calculation, so the moving average of vehicle speed may update itself rapidly to reflect recent variations in vehicle speed. Determining a weighted moving average of vehicle speed may be achieved using a number of different techniques well known to the skilled person, for example by passing the vehicle speed measurement through a low pass filter.

Having determined the moving average of vehicle speed, if the current vehicle speed is within predetermined limits either side of the average vehicle speed, the vehicle speed may be considered to be stable.

FIG. 2 shows an example of how it may be determined in Step S120 if the vehicle speed is stable. The moving average of vehicle speed, V_{AVG}, is subtracted from the current vehicle speed, V, to determine the modulus of a difference between the two measurements, |V−V_{AVG}|. In Step S210, it is determined whether or not |V−V_{AVG}| is less than a stability threshold value. If |V−V_{AVG}| is less than the stability threshold, a flag may be set in Step S220 to indicate that the vehicle speed is stable. If, however, |V−V_{AVG}| is above the stability threshold, a flag may be set in Step S230 to indicate that the vehicle speed is not stable.

The stability threshold may be set to a particular speed, for example 2 KPH, such that if the vehicle speed V is within 2 KPH either side of the moving average of vehicle speed V_{AVG}, the vehicle speed is considered to be stable. Alternatively, the stability threshold may be set to a percentage value of the moving average of the vehicle speed V_{AVG}, for example 10% of the moving average of the vehicle speed, such that if |V−V_{AVG}| is within 10% of the average vehicle speed V_{AVG}, the vehicle speed is considered to be stable.

If it is determined in Step S120 that the vehicle speed has not been stable for the threshold period of time T_{ACT2}, the control method may progress to Step S140 where the CSD is maintained in an inactive state, after which the control method may return to Step S110.

If, however, Step S120 determines that the vehicle speed has been stable for the threshold period of time T_{ACT2}, the control method may progress to Step S130, where CSD is activated.

By considering the stability of the engine speed demand and the vehicle speed, it is possible to determine whether or not CSD would be useful and activate it without any specific request from the operator. Consequently, control of the vehicle is simplified compared with a system where the operator must determine for themselves that CSD would be useful and then activate a switch to indicate that they would like CSD to activate.

It will be understood that whilst FIG. 1 shows Steps S110 and S120 being executed in that order, the steps may in fact be carried out in any order.

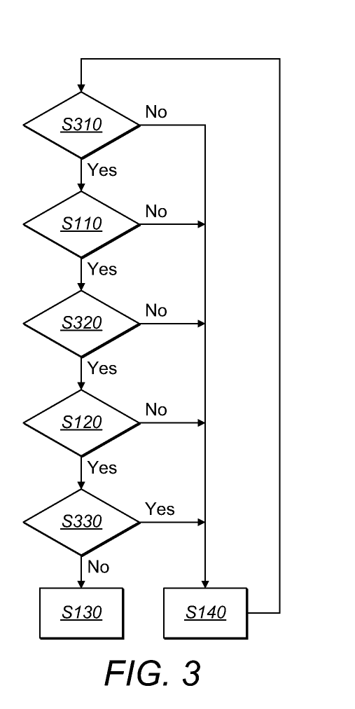

FIG. 3 shows additional method steps that may be executed in order to determine whether or not CSD should be activated. It is not necessary to implement all of the steps shown in FIG. 3 to execute control of activation of the CSD. On the contrary, it is possible to control the activation of CSD using any one or more of the steps shown in FIG. 3. However, in general, it may be determined with greater accuracy whether or not to activate CSD with each additional step shown in FIG. 3 being implemented. Furthermore, the steps shown in FIG. 3 may be implemented in any order.

In Step S310, it is determined whether or not the creeper function of the vehicle has been activated by the operator. If the creeper function is active, this indicates that the operator wishes to move the vehicle at relatively low speeds and mostly likes set a particular vehicle speed by activating the throttle lock and setting a creeper dial to a particular position. Therefore, an activated creeper function suggests that the operator may benefit from CSD.

If it is determined that the creeper function has not been activated by the operator, the control method may proceed to Step S140, where the CSD is maintained in an inactive state.

If, however, it is determined that the creeper function has been activated by the operator, the control method may proceed to Step S110, where it is determined whether or not the engine speed demand has been stable for a threshold period of time T_{ACT1}. Further details regarding Step S110 are set out above.

If it is determined that the engine speed demand has not been stable for a threshold period of time T_{ACT1} the control method may proceed to Step S140, where the CSD is maintained in an inactive state.

If, however, it is determined that the engine speed demand has been stable for a threshold period of time, the control method may proceed to Step S320, where it is determined whether or not the speed of the vehicle is above a threshold value V_{ACT2}.

As explained earlier, the speed of the vehicle may be represented by a number of different measurements, including the angular speed of the motor turning the vehicle wheels, or the speed of the vehicle relative to the surface on which it is travelling, and the measurements may be obtained using any technique well known to the skilled person.

The threshold value V_{ACT2} may be set at any value determined by the skilled person with consideration of relevant factors, such as vehicle type, engine size and type and expected operating conditions. For example, the threshold value V_{ACT2} may be set to a motor speed of 150 RPM, or more preferably 200 RPM. If the motor speed is below the threshold, it is likely that accurate control of CSD may be very difficult, and so it should not be activated. Consequently, if the vehicle speed is less than the threshold, the control method may proceed to step S140 and the CSD be maintained in an inactive state. However, if the vehicle speed exceeds the threshold, the control method may proceed to Step S120.

In Step S120, it is determined whether or not the speed of the vehicle has been stable for a threshold period of time T_{ACT2}. Further details regarding Step S120 are set out above.

If it is determined that the vehicle speed has not been stable for a threshold period of time T_{ACT2}, the control method may proceed to Step S140, where the CSD is maintained in an inactive state.

If, however, it is determined that the vehicle speed has been stable for a threshold period of time T_{ACT2}, the control method may proceed to Step S330, where it is determined whether or not a brake demand has been activated by the vehicle operator.

A brake demand may be activated by the operator by depressing a brake pedal, or by any other means that would result in the application of the vehicle brakes.

The brake demand may be considered in Step S330 to have been activated as soon as any non-zero degree of brake demand has been applied. Alternatively, Step S330 may consider a brake demand to have been activated only when the degree of brake demand activation exceeds any deadband in the brake activation means. For example, the initial depressing of a brake pedal will usually not result in the application the vehicle brakes because of a deadband region in the brake pedal. Only when the brake pedal has been depressed by a degree that exceeds the deadband region will the vehicle brakes activate.

If it is determined in Step S330 that a brake demand has been activated, the control method may proceed to Step S140, where the CSD is maintained in an inactive state.

If, however, it is determined in Step S330 that a brake demand has not been activated, the control method may proceed to Step S130, where CSD is activated.

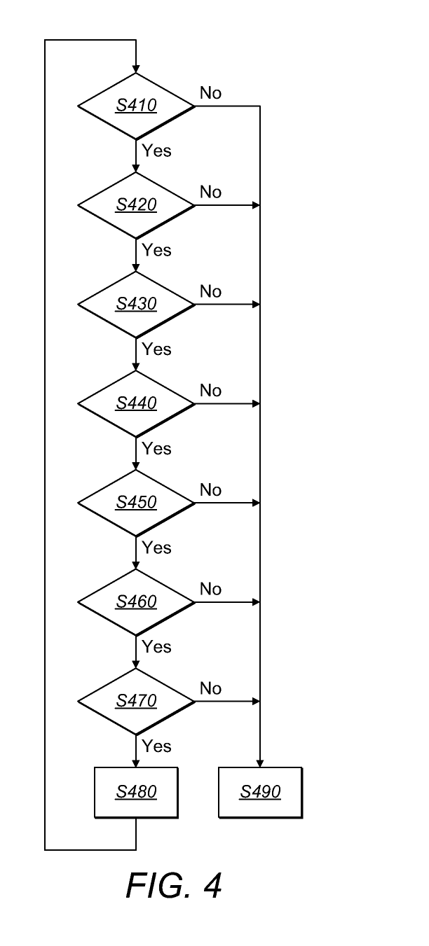

After activation of the CSD, the method steps shown in FIG. 4 may be executed to determined whether or not the CSD should remain activated or should be de-activated.

FIG. 4 shows the method steps that may be executed in order to determine whether or not the CSD should be deactivated. Consequently, to begin with, at the first step, S410, the CSD is active.

In Step S410, it is determined whether or not the creeper function is active. This step is analogous to Step S210, further details of which are set out above.

If it is determined by Step S410 that the creeper function has been deactivated, this suggests that the operator may wish to increase the vehicle speed significantly. Therefore, the control method may proceed to Step S490, where the CSD is deactivated.

If, however, it is determined by Step S410 that the creeper function is activated, the control method may proceed to Step S420, where it is determined whether or not the engine speed demand is stable.

Step S420 is analogous to Step S110, details of which are set out above. If the engine speed demand lock is turned off, the engine speed demand may still be considered to be stable if it is above a threshold level, V_{DACT1}. The threshold V_{DACT1} is analogous to the threshold V_{ACT1} in Step S110, and may be set at the same value, or a different value.

If Step S420 determines that the engine speed demand is not stable, this may indicate that the vehicle operator wishes to change the operating mode of the vehicle, for example change its speed, and so the control process may proceed to Step S490 where CSD is deactivated.

If, however, it is determined by Step S420 that the engine speed demand is stable, the control process may proceed to Step S430, where it is determined whether or not the vehicle speed is below a deactivation speed threshold value V_{DACT2}.

Step S430 is analogous to Step S320, details of which are set out earlier. The threshold speed value V_{DACT2} may be the same as V_{ACT2}, or may be set to a different threshold value. Preferably, V_{DACT2} may be less than V_{ACT2}, for example, if VACT2 is 200 RPM, V_{DACT2} may be set to 50 RPM. By setting the thresholds in such a way, hysteresis may be introduced into the system so that CSD does not regularly change simply as a result of the vehicle speed varying by small amounts either side of a single threshold value.

If the vehicle speed is determined to be below the threshold V_{DACT2}, CSD may be too difficult to maintain accurately, and should therefore be turned off.

Therefore, if Step S430 determines that the vehicle speed is below the threshold V_{DACT2}, the control method may proceed to Step S490, where CSD is deactivated.

If, however, Step S430 determines that the vehicle speed is above the threshold V_{DACT2}, the control process may proceed to Step S440, where it is determined whether or not the vehicle speed is stable.

Step S440 is analogous to Step S120, the details of which are set out above.

If Step S440 determines that the vehicle speed is unstable, CSD must be failing to function correctly, which may be caused by, for example, the vehicle encountering an extreme incline or decline. If CSD is failing to function properly, it should be turned off so that the vehicle may find a suitable speed for the conditions, until such a time that CSD may be reactivated.

Therefore, if Step S440 determines that the vehicle speed is not stable, the control method may proceed to Step S490, where CSD is deactivated.

However, if Step S440 determines that the vehicle speed is stable, the control process may proceed to Step S450, where it is determined whether or not a brake demand has been activated.

Step S450 in analogous to Step S330, details of which are set out above.

If Step S450 determines that a brake demand has been activated by the vehicle operator, it is clear that the operator wishes to change the speed of the vehicle, so the control process may proceed to Step S390 where the CSD is deactivated so that the vehicle speed may be changed.

If, however, Step S450 determines that a brake demand has not been activated by the vehicle operator, the control process may proceed to Step S460, where it is determined whether or not the vehicle operator has changed the creeper dial position by a significant amount.

The creeper dial position may be considered to have been changed by a significant amount if increases or decreases from the setting it was on at the time CSD was activated by more than a threshold amount. The threshold amount may be set by the skilled person to be any suitable value, taking relevant factors into consideration, for example vehicle type, engine type and size, and expected vehicle operation conditions. For example, the threshold amount may be set to 10%, or more preferably 5%, so that if the creeper dial position is increased or decreased from its setting when CSD was activated by more than the threshold, the creeper dial position will be considered to have changed by a significant amount.

If Step S460 determines that the operator has changed the creeper dial position by a significant amount, it is clear that the operator wishes to change the speed of the vehicle, so the control process may proceed to Step S490, where the CSD is deactivated.

If, however, Step S460 determines that the operator has not changed the creeper dial position by a significant amount, the control process may proceed to Step S470 where it is determined whether or not the vehicle engine is likely to stall.

One technique for determining whether or not the vehicle engine is likely to stall is to compare the actual speed of the engine with the engine speed demand. When the vehicle is working very hard for example if a large number of ancillary devices are operating and/or the vehicle is travelling up a very steep incline, the engine speed may decrease and be unable to match the engine speed demand. If the engine speed drops significantly below the demand level, for example if the engine speed is less than 70% of the demand level, it may be considered that the engine is likely to stall.

If the vehicle engine is considered likely to stall, CSD should be deactivated so that the vehicle speed may be allowed to reduce, which should allow the vehicle engine speed to recover to a safe level.

Therefore, if Step S470 determines that the engine speed is less than a threshold amount below the engine speed demand, for example if it is less than 70% of the engine speed demand, the vehicle engine is may be considered likely to stall and the control process may proceed to Step S490, where the CSD is deactivated so that action may safely be taken to avoid stalling of the vehicle engine, for example by decreasing the vehicle speed.

If, however, Step S470 determines that the vehicle engine is not likely to stall, the control process may proceed to Step S480, where CSD is maintained in an active state, after which the control process may return to Step S410 and begin the control steps again.

Whilst the control process shown in FIG. 4 and described above includes all of Steps S410, S420, S430, S440, S450, S460 and S470, the skilled person will readily appreciate that it is not essential that all of these steps are implemented in the control process. On the contrary, determination of whether or not CSD should be deactivated or remain activated may be carried out using any one or more of the steps shown in FIG. 4. Furthermore, the steps may be carried out in any order.

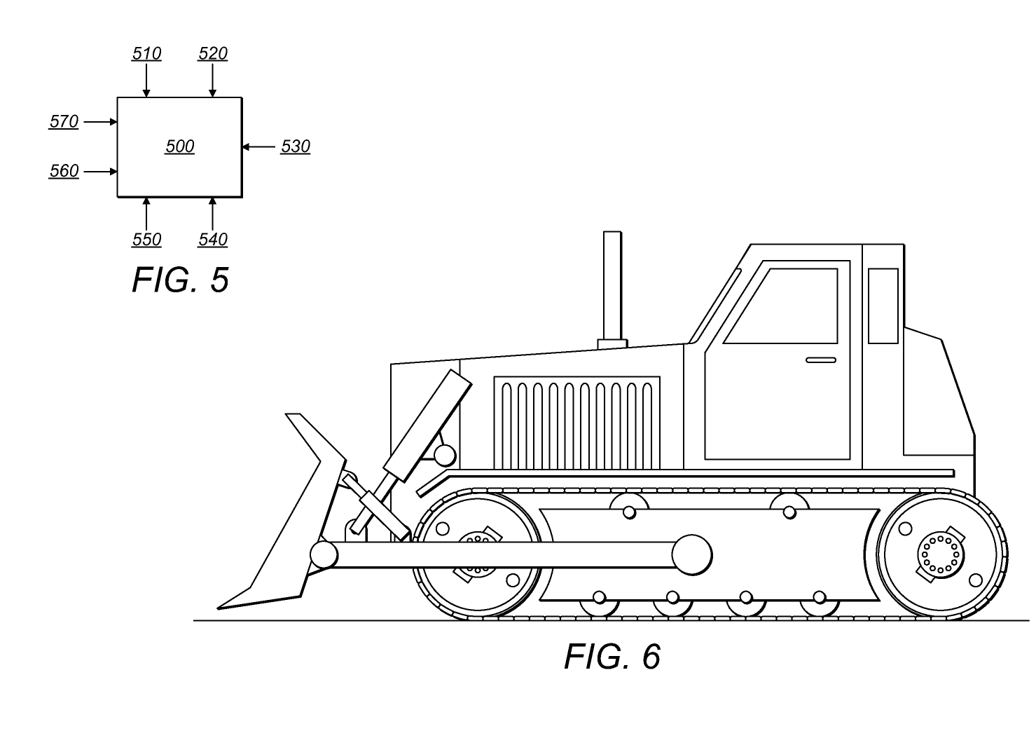

FIG. 5 shows a controller 500 in accordance with an aspect of the present disclosure.

The controller 500 may be configured to carry out the method steps described in the present disclosure.

The controller 500 may have a number of inputs that may be used in order to determine whether or not the CSD should be activated or deactivated. For example, the inputs might include, but are not limited to, at least one of an engine speed demand 510, an indication of whether or not an engine speed demand lock is engaged 520, vehicle speed 530, an indication of whether or not a creeper system is engaged 540, brake demand 550, vehicle speed demand 560 and engine speed 570.

The controller 500 may be implemented in an engine control unit, for example the Caterpillar A4:M1 or A5:M12, or as a standalone control unit.

### INDUSTRIAL APPLICABILITY

The present disclosure finds application in the control of the activation of CSD in a vehicle with non-direct transmission, without requiring the vehicle operator to determine for themselves that CSD would be of use and control a CSD request switch accordingly, this simplifying the control of the vehicle.

1. A method of controlling the enablement of a constant speed drive system in a vehicle with a non-direct transmission system, the method comprising the steps of:
enabling the constant speed drive system, if:
a speed of the vehicle is stable for a first period of time; and
an engine speed demand from an operator of the vehicle is stable for a second period of time.

2. The method of claim 1, wherein enabling the constant speed drive system is further conditional on:
the speed of the vehicle being greater than a first vehicle speed threshold.

3. The method of claim 1, wherein enabling the constant speed drive system is further conditional on:
a vehicle brake demand not being engaged by the operator of the vehicle.

4. The method of claim 1, wherein after enablement of the constant speed drive system, the constant speed drive system is disabled if:
the speed of the vehicle is not stable.

5. The method of claim 1, wherein after enablement of the constant speed drive system, the constant speed drive system is disabled if:
the engine speed demand from an operator of the vehicle is not stable.

6. The method of claim 1, wherein after enablement of the constant speed drive system, the constant speed drive system is disabled if:
the vehicle speed is less than a second vehicle speed threshold.

7. The method of claim 1, wherein after enablement of the constant speed drive system, the constant speed drive system is disabled if:
a vehicle brake demand is engaged by the operator of the vehicle.

8. The method of claim 1, wherein after enablement of the constant speed drive system, the constant speed drive system is disabled if:
a vehicle speed demand from the operator of the vehicle changes from the vehicle speed demand at the time the constant speed drive system was enabled by more than a vehicle speed demand change threshold.

9. The method of claim 1, wherein after enablement of the constant speed drive system, the constant speed drive system is disabled if:
it is determined that stalling of the vehicle engine is likely.

10. The method of claim 9, wherein stalling of the vehicle engine is determined to be likely if the engine speed is more than a threshold amount below the engine speed demand.

11. The method of claim 1, wherein:
the speed of the vehicle is stable if a difference between the speed of the vehicle and a moving average of the speed of the vehicle is less than a stability threshold.

12. The method of claim 1, wherein the engine speed demand is stable if at least one of:
an engine speed demand lock is engaged and the engine speed demand has not changed by an amount exceeding an engine speed threshold compared with the engine speed demand at the time the engine speed demand lock was engaged, and
an engine speed demand lock is not engaged and the engine speed demand exceeds an engine speed demand threshold.

13. A controller for controlling enablement of a constant speed drive system in a vehicle with a non-direct transmission system, the controller being arranged to enable the constant speed drive system if:
a speed of the vehicle is stable for a first period of time; and
an engine speed demand from an operator of the vehicle is stable for a second period of time.

14. An engine unit comprising:
the controller of claim 13, and
an engine.

15. A vehicle comprising the engine unit of claim 14.

16. The method of claim 2, wherein enabling the constant speed drive system is further conditional on:
a vehicle brake demand not being engaged by the operator of the vehicle.

17. The method of claim 2, wherein after enablement of the constant speed drive system, the constant speed drive system is disabled if:
the speed of the vehicle is not stable.

18. The method of claim 2, wherein after enablement of the constant speed drive system, the constant speed drive system is disabled if:
the engine speed demand from an operator of the vehicle is not stable.

19. The method of claim 2, wherein after enablement of the constant speed drive system, the constant speed drive system is disabled if:
the vehicle speed is less than a second vehicle speed threshold.

20. The method of claim 2, wherein after enablement of the constant speed drive system, the constant speed drive system is disabled if:
a vehicle brake demand is engaged by the operator of the vehicle.
